(19) United States
(12) Patent Application Publication
(10) Pub. No.: US 2012/0015285 A1
(43) Pub. Date: Jan. 19, 2012

(54) SOLID OXIDE FUEL CELL

(76) Inventor: Jun-Won Suh, Yongin-si (KR)

(21) Appl. No.: 12/981,368

(22) Filed: Dec. 29, 2010

(30) Foreign Application Priority Data
Jul. 15, 2010 (KR) 10-2010-0068463

(51) Int. Cl. H01M 2/30

(52) U.S. Cl. 429/522

(57) ABSTRACT

A solid oxide fuel cell includes a unit cell, a cell cap, an internal current collector and an external current collector. The unit cell includes a first electrode, an electrolyte and a second electrode. The cell cap seals one end of the unit cell, and one or more through-holes are formed in the center axis direction of the unit cell in the cell cap. The internal current collector collects current in the interior of the unit cell. The external current collector is provided to the interior of the through-hole to be electrically coupled to the internal current collector. In the solid oxide fuel cell, a welding portion is formed to connect an end of the internal current collector and an end of the external current collector to each other through the through-hole of the cell cap and to seal the through-hole. Accordingly, contact resistance is decreased, thereby enhancing current collection efficiency.

### CROSS-REFERENCE TO RELATED APPLICATION

This application claims priority to and the benefit of Korean Patent Application No. 10-2010-0068463, filed on Jul. 15, 2010, in the Korean Intellectual Property Office, the entire content of which is incorporated herein by reference.

### BACKGROUND

1. Field

The following description relates to a fuel cell, and more particularly, to a connection structure of current collectors in a solid oxide fuel cell.

2. Description of the Related Art

A current collector used in a solid oxide fuel cell should have high electrical conductivity for electrical connection and chemical stability under an atmosphere utilized with a cathode and an anode of the solid oxide fuel cell. The current collector should also have correspondence of thermal expansion coefficients of components that constitute a unit cell in a fuel cell, mechanical strength, processing easiness, economical efficiency, and the like.

Also, in the case of a fuel cell provided with a cell cap, the connection structure between current collectors of the interior and exterior of the fuel cell is an important factor that should be considered so as to reduce electrical resistance while maintaining desired sealing effect.

### SUMMARY

An aspect of an embodiment of the present invention is directed toward a solid oxide fuel cell in which unnecessary contact resistance is reduced in the connection structure of internal and external current collectors in the interior of its unit cell, so that current collection efficiency can be increased.

An aspect of an embodiment of the present invention is directed toward a solid oxide fuel cell which can prevent or protect a current collection structure from being broken due to a weak adhesion at the welding portion between internal and external current collectors.

According to an embodiment of the present invention, there is provided a solid oxide fuel cell including: a unit cell comprising a first electrode, an electrolyte and a second electrode; a cell cap that seals one end of the unit cell, the cell cap having one or more through-holes formed therein; an internal current collector that collects current in the interior of the unit cell; and an external current collector provided to the interior of the through-hole to be electrically coupled to the internal current collector, wherein a welding portion is formed to connect an end of the internal current collector and an end of the external current collector to each other through the through-hole of the cell cap and to seal the through-hole.

The welding portion may be a melted and then solidified portion of at least one of the internal and external current collectors. The welding portion may use heterogeneous metal as filler metal.

The cell cap may be formed of stainless steel. The cell cap may be formed of an electrical non-conductor material.

The internal and external current collectors may be formed of a Ni or Ag wire.

The ends of the internal and external current collectors may be connected to each other at an upper or lower surface of the cell cap through the through-hole. The internal current collector may be formed of a Ni wire, and the external current collector may be formed of an Ag wire.

One end of the Ni wire connected to the Ag wire may be melted and solidified, so that the Ni wire is connected to the Ag wire. Therefore, the top or bottom of the through-hole may be sealed, or the interior of the through-hole may be directly sealed.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a sectional view showing a unit cell in which a cell cap is used as a current collecting member in a fuel cell.

FIG. 2 is a cross-sectional view of the unit cell according to the embodiment of the present invention.

FIG. 3 is a longitudinal sectional view of a unit cell provided with a current collection structure according to an embodiment of the present invention.

FIG. 4 is a perspective view of a cell cap according to the embodiment of the present invention.

FIG. 5A is a perspective view showing a state that a cell cap and internal and external current collectors are connected according to an embodiment of the present invention.

FIG. 5B is a longitudinal sectional view showing a state in which a cell cap and internal and external current collectors are connected according to an embodiment of the present invention.

FIG. 5C is a longitudinal sectional view showing a state in which a cell cap and internal and external current collectors are connected according to an embodiment of the present invention.

FIGS. 6A to 6C are longitudinal sectional views showing positions of the welding portion between the internal and external current collectors according to embodiments of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. In the drawings, the thickness or size of layers are exaggerated for clarity and not necessarily drawn to scale.

A fuel cell module refers to an assembly including a fuel cell stack that converts chemical energy into electrical energy and heat energy using electrochemical method. That is, the fuel cell module includes a fuel cell stack; a piping system through which fuel, oxidant, coolant, discharge and the like are moved; a wiring system through which electricity produced by the stack is moved; a portion for controlling or monitoring the stack; and a portion for taking an action on the stack having an abnormal state.

An aspect of the present invention relates to a current collector that electrically connects the interior and exterior of its unit cell to collect current and the structure of the unit cell. Hereinafter, exemplary embodiments of the present invention will be described in more detail.

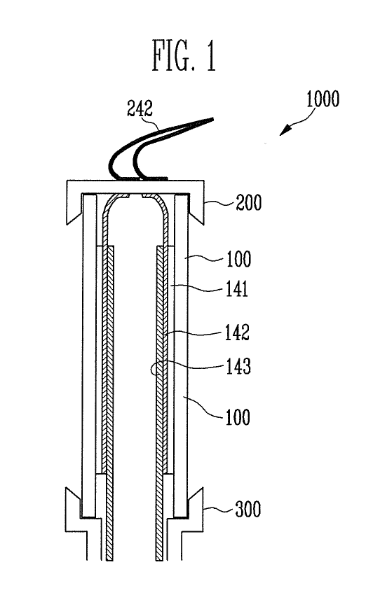

FIG. 1 is a sectional view showing a unit cell in which a cell cap is used as a current collecting body in a fuel cell.

In the unit cell 1000 shown in FIG. 1, an internal current collector 142 is adhered to an inner surface of a cell cap 200 that covers one end of the unit cell 1000 using a method such as spot welding, and an external current collector 242 is fixed to an outer surface of the cell cap 200 using the same or substantially the same method such as spot welding so that they are electrically connected with each other.

In this instance, the cell cap 200 that covers the one end of the unit cell 1000 is made of a stainless steel material that serves as an electrical conductor, but resistance may be increased at a contact portion between the internal current collector 142 and the cell cap 200 or between cell cap 200 and the external current collector 242. If a spot welding portion is oxidized or receives a repeated stress applied thereto, an electrical short circuit may occur, or the resistance may be increased. The stainless steel material used in the cell cap 200 has high oxidation resistance due to a passivating film. However, in a case where the stainless steel material is used as an electrical connection member, the passivating film increases surface resistance, and therefore, unnecessary power loss may occur.

Also, in one embodiment, the internal current collector 142 is made of a wire using Ni as its main component, and the external current collector 242 is made of a wire using Ag as its main component. Due to economic cost, a Ni wire should be used, but an Ag wire with high oxidation resistance should be used in a case where the exterior of unit cell is under an oxidation atmosphere. However, the spot welding is hard to perform when the Ag wire is involved because the Ag wire has high thermal conductivity. Therefore, there may be an inconvenience in which the spot welding is performed with respect to a separate Ni wire, and the Ag wire then comes in electrical contact with the Ni wire.

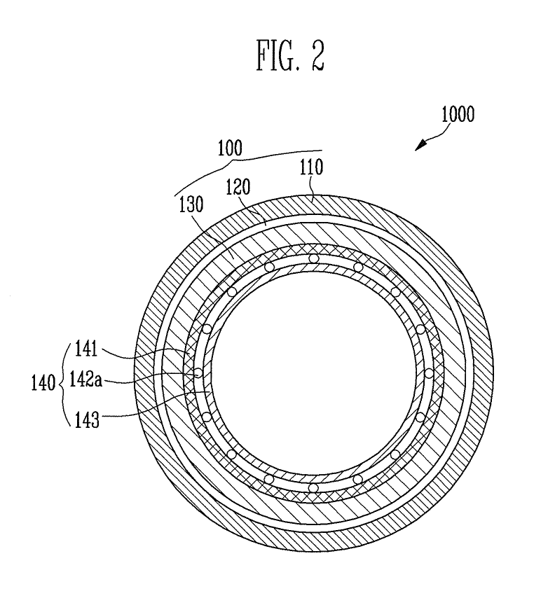

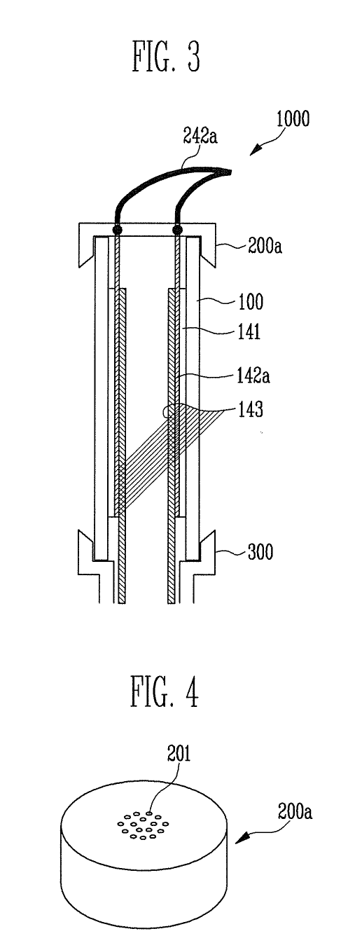

As shown in FIGS. 2 and 3, a solid oxide fuel cell according to an embodiment of the present invention includes a unit cell 1000, a cell cap 200a, first electrode current collector 142a and 242a (composed of an external current collector 142a and an internal current collector 242a). A separate second electrode current collector may be formed on the outer circumferential surface of a second electrode that is the cathode.

Also, as shown in FIGS. 2 and 3, the unit cell 1000 according to this embodiment is formed to have a hollow circular or polygonal cylinder shape. FIG. 2 shows a cross section of the unit cell. In the unit cell 1000 shown in this figure, an electrode layer 100 is first formed, which includes a first electrode 130 that is an anode, an electrolyte 120 and a second electrode 110 that is a cathode, and an internal current collector 142a made of a metal wire is formed on the inner circumferential surface of the electrode layer 100. In this instance, a metal felt layer 141 with a porous structure for current collection may be additionally formed between the first electrode 130 of the electrode layer 100 and the internal current collector 142a as shown in this figure. Also, a metal tube 143 may be additionally formed on the inner circumferential surface of the internal current collector 142a.

Generally, the second electrode 110 that is a cathode is formed of a pure electron conductor or mixed conductor such as a LaMnO₃-based or LaCoO₃-based material, which has high ion and electron conductivity, stability under an oxygen atmosphere, and having little or no chemical reaction with the electrolyte (electrolytic layer) 120 which will be described later in more detail. The electrolyte 120 is a portion that serves as a path along which oxygen ions produced through the cathode and hydrogen ions produced through the anode which will be described later in more detail are moved. The electrolyte (electrolytic layer) 120 is made of a ceramic material having a compactness with which gas does not penetrate the ceramic material. Particularly, yttria stabilized zirconia (hereinafter, referred to as “YSZ”) obtained by adding a small amount of Y₂O₃ to ZrO₂ is used to form the electrolyte (the electrolytic layer) 120. The YSZ is formed into a structure having high ion conductivity under oxidation and reduction atmospheres and chemical and physical stability. The first electrode 130 that is an anode is a portion to which hydrogen gas that is fuel of the fuel cell is supplied. The anode is basically made of a ceramic material such as YSZ. Particularly, a metal ceramic complex (cermet) such as NiO-8YSZ or Ni-8YSZ is used as the anode. Here, the metal ceramic complex (cermet) has a low economical cost and stability under a high-temperature reduction atmosphere.

In FIG. 3, the internal and external current collectors 142a and 242a of this embodiment may each be formed using Ni which is relatively low in economical cost as a main component. However, the internal and external current collectors 142a and 242a may each be formed using Ag as a main component under an environment in which their corrosion is serious. In the embodiment as discussed in more detail below, Ni is used as a main component in the internal current collector 142a, and Ag is used as a main component in the external current collector 242a.

In addition, referring to FIGS. 2 and 3, a metal tube 143 may be further provided in one embodiment. The metal tube 143 is formed to have a hollow circular or polygonal cylinder shape, corresponding to the shape of the unit cell 1000. The metal tube 143 is provided to the interior of the first electrode layer 130 to pressurize (or push) the internal current collector 142a to the inner circumferential surface of the first electrode layer 130. The metal tube 143 also serves as an auxiliary current collector between unit cells connected through a cell connector 300. The metal tube 143 may be formed of a stainless steel material because of its structural stability and electrical conductivity.

In this instance, a porous metal felt layer 141 may be further provided between the internal current collector 142a and the inner circumferential surface of the first electrode layer 130. In this case, the metal felt layer 141 is formed to be porous so as to allow fuel to pass therethrough and to enhance current collecting efficiency as a current collector. The porous metal felt layer 141 may be formed using nickel (Ni) as a main component so that the current collecting efficiency can be further enhanced.

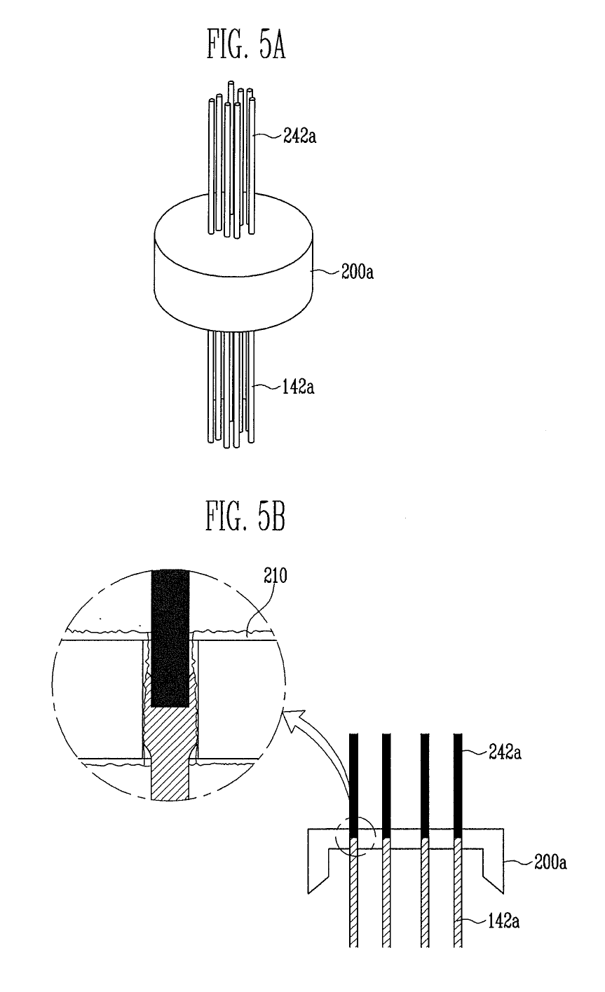

The cell cap 200a of this embodiment is provided to cover one end of the unit cell 1000, and a plurality of through-holes 201 (see FIG. 4) may be formed to extend along the center axis direction of the unit cell 1000 in the cell cap 200a so that the internal and external current collectors 142a and 242a are connected to each other therethrough. In this instance, the cell cap 200a may be formed of stainless steel that is a conductive material. However, since the internal and external current collectors 142a and 242a are directly connected to each other through the through-holes 210, the cell cap 200a may be formed of various suitable materials including a non-conductor material.

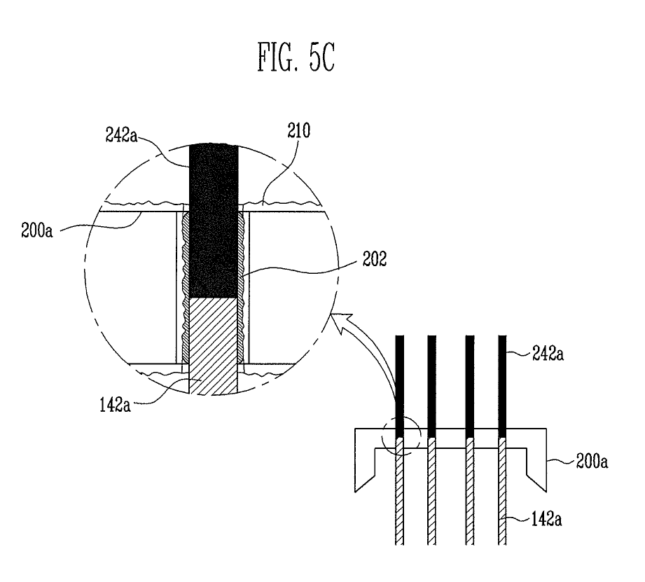

The connection structure of internal and external current collectors will be described in more detail with reference to FIGS. 4 to 5C. FIG. 4 is a perspective view of a cell cap according to an embodiment of the present invention. FIG. 5A shows a state in which a cell cap and internal and external current collectors are connected according to an embodiment of the present invention. FIGS. 5B and 5C are enlarged longitudinal sectional views specifically showing the connection state.

Referring to FIG. 4, the cell cap 200a of this embodiment is formed in the shape of a stopper capable of accommodating each of both ends of the unit cell 1000, corresponding to the sectional shape of the outer circumferential surface of the unit cell 1000. A plurality of through-holes 201 that pass through the cell cap 200a extending along the center axis direction of the unit cell 1000 are formed into a top side of the cell cap 200a.

Referring to FIGS. 5A to 5C, one end of the unit cell 1000 is inserted into the cell cap 200a, and a welding process such as brazing is performed between the cell cap 200a and the outer circumferential surface of the unit cell 1000 so that sealing is made at portions of the cell cap 200a except at the through-holes 201. In addition, a cell connector 300 as shown in FIG. 1 is provided to the other end of the unit cell 1000, to which the cell cap 200a is not provided, so as to be connected to another unit cell therethrough.

In this embodiment, the internal and external current collectors 142a and 242a are formed in a wire shape. The internal current collector 142a is provided to the interior of the unit cell 1000 so that current collection is performed in the interior of the unit cell 1000. The internal current collector 142a is connected to the external current collector 242a provided to the exterior of the unit cell 1000.

In addition, an end of the internal current collector 142a and an end of the external current collector 242a come in contact with each other while being inserted into a corresponding one (i.e., a through-hole 201) of the through-holes 201 formed in the cell cap 200a. In this instance, a welding portion is formed at the contact portion between the internal and external current collectors 142a and 242a. The welding portion refers to a portion at which two contact portions are fixed to each other through a melting and solidification process of a portion of parent or filler metal. In this instance, the welding portion formed at the contact portion between the internal and external current collectors 142a and 242a functions to fix the internal and external current collectors 142a and 242a to each other and to seal the through-hole 210 formed in the cell cap 200a.

As described above, the internal and external current collectors 142a and 242a are formed using Ni and Ag as main components, respectively. As shown in FIG. 5B, the parent metal at one or both sides of the internal or external current collector 142a or 242a is melted by pressure and/or fusion welding and then solidified, thereby forming the welding portion.

In addition, the welding portion may be formed by adding heterogeneous metal that is an electrical conductor as filler metal and performing brazing. In this case, as shown in FIG. 5C, the internal and external current collectors 142a and 242a are inserted into the through-hole 201, and an extra space of the through-hole 201 is then filled with a filler metal 202 in a melted state. Subsequently, the filler metal 202 is solidified, so that the internal and external current collectors 142a and 242a are fixed to each other and the through-hole 201 is sealed.

In a case where the cell cap 200a of this embodiment is formed of austenite- or ferrite-based stainless steel, a passivating film 210 is formed on the surface of the cell cap 200a because of the property of stainless steel. As described above, in FIG. 1, the passivating film 210 increases contact resistance, and therefore, current collection efficiency is lowered. However, in this embodiment, the internal and external current collectors 142a and 242a of the cell cap 200a are fixed while coming in direct contact with each other, and the passivating film 210 is formed on the surface of the cell cap 200a, so that it is possible to prevent or protect current collection efficiency from being lowered. That is, the passivating film 210 can prevent current transferred from the internal and external current collectors 142a and 242a from being leaked to other portions of the cell cap 200a. In this viewpoint, if the plurality of through-holes 210 are formed in the cell cap 200a as described above, the cell cap 200 may even be formed of an electrical non-conductor material rather than a conductive material such as stainless steel. That is, in one embodiment, the cell cap 200a is formed using a ceramic material that is an electrical non-conductor strong against (or more resistant to) oxidation, thereby forming the cell cap 200a that increases the current collection efficiency and is stronger against (or more resistant to) oxidation.

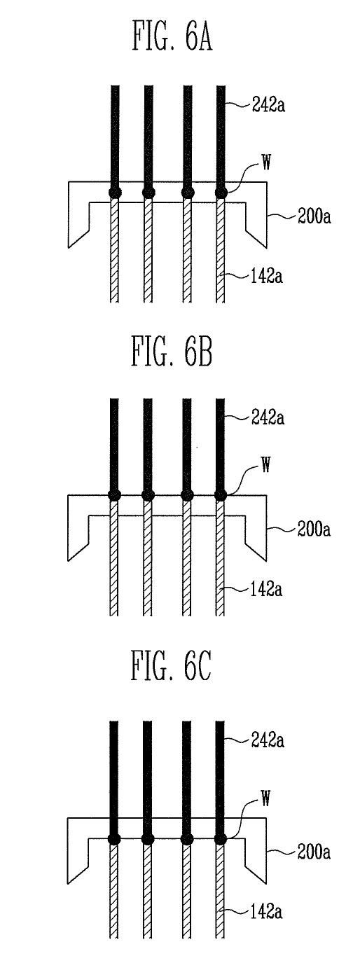

FIGS. 6A to 6C are longitudinal sectional views showing positions of welding portions between the internal and external current collectors according to embodiments of the present invention.

As shown in FIGS. 6A to 6C, a welding point W for fixing the internal and external current collectors 142a and 242a and sealing the through-hole 210 may be formed at any position in the through-hole 210. That is, as shown in FIG. 6A, the welding point W is preferably formed in the middle (e.g., longitudinal midsection) of the through-hole 210 because the fixing force between the internal and external current collectors 142a and 242a is reinforced. However, the welding point W may be formed at an upper surface of the cell cap 200a as shown in FIG. 6B, or may be formed at a lower surface of the cell cap 200a as shown in FIG. 6C.

That is, in one embodiment, an end of the internal current collector 142a and an end of the external current collector 242a are connected to each other at the upper surface of the cell cap 200a through the through-hole 201 of the cell cap 200a. In this instance, the internal current collector 142a is formed of a Ni wire, and the external current collector 242a is formed of an Ag wire. One end of the Ni wire connected to the Ag wire is melted and solidified, so that the Ni wire is connected to the Ag wire, and the top of the through-hole 201 is sealed.

In another embodiment, the ends of the internal and external current collectors 142a and 242a are connected to each other at the lower surface of the cell cap 200a through the through-hole 201 of the cell cap 200a. In this instance, the internal current collector 142a is formed of a Ni wire, and the external current collector 242a is formed of an Ag wire. The one end of the Ni wire connected to the Ag wire is melted and solidified, so that the Ni wire is connected to the Ag wire, and the bottom of the through-hole 201 is sealed.

It will be apparent that the ends of the internal and external current collectors 142a and 242a may be directly connected to each other in the through-hole 210 of the cell cap 200a.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A solid oxide fuel cell comprising:
a unit cell comprising a first electrode, an electrolyte and a second electrode;
a cell cap for sealing one end of the unit cell, the cell cap having a through-hole formed therein;
an internal current collector for collecting current in the interior of the unit cell; and
an external current collector provided to the interior of the through-hole to be electrically coupled to the internal current collector,
wherein a welding portion is formed to connect an end of the internal current collector and an end of the external current collector to each other through the through-hole of the cell cap and to seal the through-hole.

2. The solid oxide fuel cell according to claim 1, wherein the welding portion is a melted and then solidified portion of at least one of the internal and external current collectors.

3. The solid oxide fuel cell according to claim 1, wherein the welding portion comprises heterogeneous metal as filler metal.

4. The solid oxide fuel cell according to claim 1, wherein the cell cap is composed of stainless steel.

5. The solid oxide fuel cell according to claim 1, wherein the cell cap is composed of an electrical non-conductor material.

6. The solid oxide fuel cell according to claim 1, wherein the internal and external current collectors are composed of a Ni wire.

7. The solid oxide fuel cell according to claim 1, wherein the internal current collector is composed of a Ni wire, and the external current collector is composed of an Ag wire.

8. The solid oxide fuel cell according to claim 1, further comprising a metal tube having a hollow circular or polygonal cylinder shape corresponding to the shape of the unit cell, the metal tube being provided to the interior of the first electrode to pressurize the internal current collector to the inner circumferential surface of the first electrode.

9. The solid oxide fuel cell according to claim 8, wherein the metal tube is composed of stainless steel.

10. The solid oxide fuel cell according to claim 8, further comprising a porous metal felt layer interposed between the internal current collector and the inner circumferential surface of the first electrode.

11. The solid oxide fuel cell according to claim 10, wherein the metal felt layer comprises Ni as a main component.

12. The solid oxide fuel cell according to claim 1, wherein the ends of the internal and external current collectors are connected to each other at an upper surface of the cell cap through the through-hole.

13. The solid oxide fuel cell according to claim 12, wherein the through-hole through which the internal current collector passes is sealed through filler metal, the filler metal being heterogeneous metal.

14. The solid oxide fuel cell according to claim 1, wherein the ends of the internal and external current collectors are connected to each other at a lower surface of the cell cap through the through-hole.

15. The solid oxide fuel cell according to claim 14, wherein the through-hole through which the external current collector passes is sealed through filler metal, the filler metal being heterogeneous metal.

16. The solid oxide fuel cell according to claim 1, wherein the ends of the internal and external current collectors are connected to each other in the through-hole of the cell cap.

17. The solid oxide fuel cell according to claim 16, wherein the through-hole through which the internal and external current collectors pass is sealed through filler metal, the filler metal being heterogeneous metal.

18. The solid oxide fuel cell according to claim 1, wherein the through-hole of the cell cap comprises a plurality of through-holes.

19. The solid oxide fuel cell according to claim 18, wherein the internal current collector comprises a plurality internal current collectors, and the external current collector comprises a plurality of internal current collectors, and wherein the plurality of internal current collectors are electrically coupled to the plurality of external current collectors through the plurality of through-holes.

20. The solid oxide fuel cell according to claim 1, wherein the internal and external current collectors physically contact each other through the through-hole.
